(19) United States
(12) Patent Application Publication
(10) Pub. No.: US 2025/0217397 A1
(43) Pub. Date: Jul. 3, 2025

(54) DATA QUERY METHOD AND APPARATUS BASED ON LARGE LANGUAGE MODEL, AND COMPUTER PROGRAM PRODUCT

(71) Applicant: Baidu USA LLC, Sunnyvale, CA (US)

(72) Inventors: Hao TIAN, Sunnyvale, CA (US); Xi CHEN, Sunnyvale, CA (US); Xiaojue ZHANG, Sunnyvale, CA (US); Kaisheng SONG, Sunnyvale, CA (US); Jeff WANG, Sunnyvale, CA (US); Zelin ZHAO, Sunnyvale, CA (US)

(73) Assignee: Baidu USA LLC, Sunnyvale, CA (US)

(21) Appl. No.: 19/085,886

(22) Filed: Mar. 20, 2025

(51) Int. Cl. G06F 16/334; G06F 40/205; G06F 40/40

(52) U.S. Cl. CPC G06F 16/3344; G06F 40/205; G06F 40/40

(57) ABSTRACT

A data query method and apparatus based on a large language model, an electronic device, a storage medium, and a computer program product are provided. The method may include: parsing a query request of a target object and determining an object demand of the target object, according to object background information of the target object by using a large language model; adjusting the query request according to the object demand, and generating an adjusted query request; and performing data query according to the adjusted query request to obtain a data query result.

### TECHNICAL FIELD

The present disclosure relates to the field of computer technologies, in particular, to the field of artificial intelligence large models, natural language understanding, and data recommendation technologies, and more particularly, to a data query method and apparatus based on a large language model, an electronic device, a storage medium, and a computer program product, which may be applied in a data recommendation scenario.

### BACKGROUND

In a conventional search and recommendation system, a user needs to manually adjust a query term to instruct the search and recommendation system to perform a data search. The matching degree between the search results returned by the search and recommendation system and the user is low, and in particular, it is difficult to accurately capture the deep intention of the user when processing the fuzzy query.

### SUMMARY

The present disclosure provides a data query method and apparatus based on a large language model, an electronic device, a storage medium, and a computer program product.

According to a first aspect, there is provided a data query method based on a large language model, including: parsing a query request of a target object and determining an object demand of the target object, according to object background information of the target object by the large language model; adjusting the query request according to the object demand, and generating an adjusted query request; and performing data query according to the adjusted query request to obtain a data query result.

According to a second aspect, there is provided a data query apparatus based on a large language model, including a parsing unit configured to parse a query request of a target object and determine an object demand of the target object, according to object background information of the target object by using the large language model; an adjustment unit configured to adjust the query request based on the object demand to generate an adjusted query request; and a query unit configured to perform a data query according to the adjusted query request to obtain a data query result.

According to a third aspect, there is provided an electronic device including at least one processor; and a memory in communication with the at least one processor; where the memory stores instructions executable by the at least one processor, the instructions being executed by the at least one processor to enable the at least one processor to perform the method as described in any of the implementations of the first aspect.

According to a fourth aspect, there is provided a non-transitory computer-readable storage medium storing computer instructions for causing a computer to perform a method as described in any of the implementations of the first aspect.

According to a fifth aspect, there is provided a computer program product including a computer program which, when executed by a processor, implements a method as described in any of the implementations of the first aspect.

It is to be understood that the description in this section is not intended to identify key or critical features of the embodiments of the disclosure, nor is it intended to limit the scope of the disclosure. Other features of the present disclosure will become readily apparent from the following description.

### BRIEF DESCRIPTION OF THE DRAWINGS

The drawings are for a better understanding of the present disclosure and do not constitute a limitation of the present disclosure:

FIG. 1 is an exemplary system architecture diagram to which an embodiment of the present disclosure may be applied;

FIG. 2 is a flowchart of an embodiment of a data query method based on a large language model according to the present disclosure;

FIG. 3 is a block diagram of an embodiment of a data query system based on a large language model according to the present disclosure;

FIG. 4 is a schematic diagram of an application scenario of a data query method based on a large language model according to the present embodiment;

FIG. 5 is a flowchart of yet another embodiment of a data query method based on a large language model according to the present disclosure;

FIG. 6 is a block diagram of an embodiment of a data query apparatus based on a large language model according to the present disclosure;

FIG. 7 is a schematic structural diagram of a computer system adapted for implementing embodiments of the present disclosure.

### DETAILED DESCRIPTION OF EMBODIMENTS

The following will illustrate the exemplary embodiments of the present disclosure in combination with the accompanying drawings. Various details of the embodiments of the present disclosure are included to facilitate understanding, and they should be regarded as merely exemplary. Therefore, those of ordinary skill in the art should recognize that various changes and modifications may be made to the embodiments described herein without departing from the scope and spirit of the present disclosure. Similarly, for clarity and conciseness, descriptions of well-known functions and structures are omitted in the following description.

In the technical solution of the present disclosure, the processes of collecting, storing, using, processing, transmitting, providing, and disclosing the user's personal information all comply with the provisions of the relevant laws and regulations, and do not violate the public order and good customs.

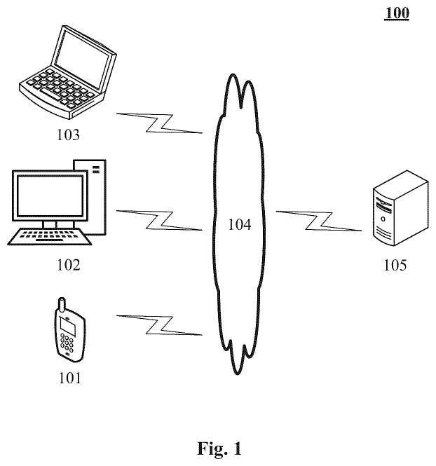

FIG. 1 illustrates an exemplary architecture 100 in which a data query method and an data query apparatus based on a large language model of the present disclosure may be applied.

As shown in FIG. 1, the system architecture 100 may include terminal devices 101, 102, 103, a network 104, and a server 105. The communication connection between the terminal devices 101, 102, 103 constitutes a topology network, and the network 104 serves as a medium for providing a communication link between the terminal devices 101, 102, 103 and the server 105. Network 104 may include various types of connections, such as wired, wireless communication links, or fiber optic cables, among others.

The terminal devices 101, 102, 103 may be hardware devices or software that support network connections for data interaction and data processing. When the terminal devices 101, 102, 103 are hardware, they may be various electronic devices supporting functions of network connection, information acquisition, interaction, display, processing, and the like, including but not limited to a smartphone, a tablet computer, an electronic book reader, a laptop portable computer, a desktop computer, and the like. When the terminal devices 101, 102, and 103 are software, they may be installed in the electronic devices listed above. They may be implemented, for example, as a plurality of software pieces or software modules for providing distributed services, or as a single software piece or software module, which is not specifically limited herein.

The server 105 may be a server that provides various services, for example, a background processing server that acquires a query request sent by a target object through the terminal devices 101, 102, and 103, and determines a data query result corresponding to the query request based on a large language model. Alternatively, the server may feed back the data query result to the terminal device. As an example, server 105 may be a cloud server.

It should be noted that the server may be hardware or software. When the server is hardware, the server may be implemented as a distributed server cluster composed of multiple servers, or a single server. When the server is software, the server may be implemented as a plurality of software pieces or software modules (e.g., software pieces or software modules used to provide distributed services) or as a single software piece or software module, which is not specifically limited herein.

It should also be noted that the data query method based on a large language model provided in the embodiments of the present disclosure is generally executed by the server, but not excluded from being executed by the terminal device, or the possibility of execution by the server and the terminal device in cooperation with each other. Accordingly, the parts (for example, the units) included in the data query apparatus based on the large language model may be all arranged in the server, may be all arranged in the terminal device, or may be arranged in the server and the terminal device respectively.

It should be understood that the number of terminal devices, networks and servers in FIG. 1 is merely illustrative. There may be any number of terminal devices, networks, and servers as desired for implementation. When the electronic device on which the data query method based on a large language model runs does not require data transmission with other electronic devices, the system architecture may include only the electronic device on which the data query method based on a large language model runs, such as a terminal device or a server.

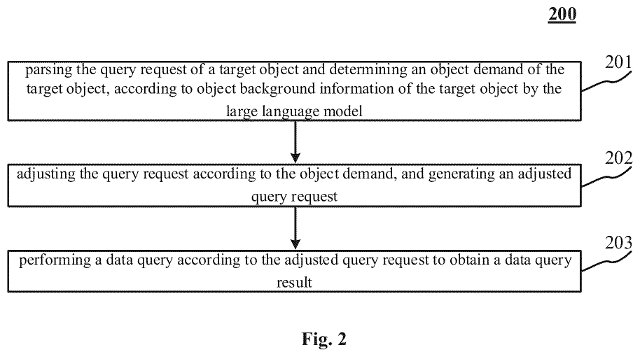

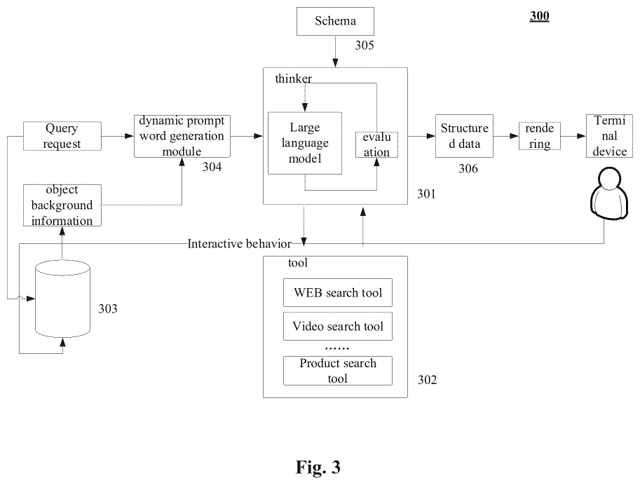

Referring to FIG. 2, FIG. 2 is a flowchart of a data query method based on a large language model according to an embodiment of the present disclosure. With continued reference to FIG. 3, an interactive schematic diagram of a large language model based data query system is shown. In the process 200, the following steps are included.
Step 201 includes: parsing the query request of a target object and determining an object demand of the target object, according to object background information of the target object by the large language model.

In this embodiment, the execution body of the data query method based on the large language model (for example, the server in FIG. 1) may acquire the query request of the target object and, parse the query request of the target object and determine the object demand of the target object, according to the object background information of the target object by the large language model. The object demand is used to characterize the true, complete needs and intentions of the target object.

The target object is, for example, an object such as a person, another intelligent device, or an artificial intelligence assistant. The object background information of the target object includes, but is not limited to, user portrait data of the target object, context data of a query request, an item to which the query request relates, a service-related market environment, and the like. The user portrait data includes basic attribute data, preference and interest data, social data, and the like of the user; the context information includes a history query request and a history data query result corresponding to the history query request; and a product market environment is, for example, a trend of change in demand, sales volume, market share, etc. for a particular product. The service market environment is, for example, a development trend of the service industry, and the service industry is, for example, a financial service, a health care service, a tourism service, and the like. It should be noted that the object background information is collected with the authorization of the user. Taking the case where the target object is a person as an example, a display interface indicating the user authorization is presented to the user through a preset terminal of a user. Data collection is carried out only when the user consents, that is, when the user authorization is obtained.

As an example, first, the execution object selects background information related to the target object from the background information database 303, for example, selects background information related to the unique identification from the background information database based on the unique identification of the target object. Then, the query request of the target object is input into the large language model, and the request is preliminarily parsed by the natural language understanding capability of the model, and the key information and the core questions therein are extracted; then, the preliminary parsing result is fused with the determined background information and input to the large language model for depth analysis. The model takes into account the background information of the target object, and further understands and interprets the query request. Finally, based on the depth analysis result, the large language model generates an object demand of the target object. Alternatively, in order to verify the accuracy of the object demand, multiple rounds of interaction with the target object may be performed in the form of a question. The large language model is deployed in a Thinker module, which serves as the core processing unit of the entire intelligent system and is driven by the advanced large language model.

As yet another example, first, a knowledge map covering various dimensions of knowledge is constructed. The knowledge field covered by the knowledge map can cover various query requests corresponding to the target object. The background information of the target object is then mapped to a knowledge map to find nodes and paths associated with the background information. Meanwhile, the query request of the target object is subjected to natural language processing, the key semantic information in the query request is extracted for matching and searching in the knowledge map. For example, regarding the query request of “how to improve the battery life” made by an enterprise focusing on the research and development of new energy vehicle batteries, the model associates its background information (such as the enterprise's technical field, research and development direction, etc.) with the relevant nodes in the knowledge graph. At the same time, the model conducts a semantic analysis of “improving the battery life” in the query request to find the relevant technical paths and solutions in the knowledge graph. Finally, by analyzing the association paths and weights between the background information nodes and the semantic nodes of the query request in the knowledge graph, the potential demands and key concerns of the target object are determined. The node combinations with shorter association paths and higher weights often represent more core concerns of the target object. For instance, if in the knowledge graph, the association paths from the background information nodes of the target object to the nodes such as “solid-state battery technology” and “construction of charging facilities” are short and the weights are high, then the model may determine that the demand of the target object may be to learn about these cutting-edge technologies and development trends directly related to improving the battery life, as well as how to apply them in the enterprise's research and development and market layout.

In some alternative implementations of the present embodiment, the above execution body may perform the above-described step 201 by the following way.

The first step includes: determining a demand scenario corresponding to the target object and a process stage of the target object in the demand scenario according to the object background information of the target object.

In the present implementation, the object background information of the target object is input to the large language model, and the large language model may determine an demand scenario to which the query request of the target object is directed and a process stage of the target object in the demand scenario based on understanding of the natural language of the object background information.

The demand scenario is, for example, an e-merchant shopping scene (more specifically, a purchase scenario of an item, for example), a personalized content (e.g., news, short video) recommendation scenario, an intelligent assistant and an interactive search scene, a cross-domain information mining and recommendation scenario, and a business intelligence and precision marketing scenario.

The process stage in the demand scenario refers to a segment or step with relative independence and a specific function, which is divided from a series of ordered, interrelated activities or processes according to the nature of the activities, the objectives, and their position and role in the overall process.

As an example, in a marketing scenario, the process stage is the journey stage in the marketing funnel model. The journey stage generally refers to the various stages the customer undergoes from initial contact with the brand or product to the final completion of the purchase and becoming a loyal customer. The journey stage covers the psychological and behavioral changes that customers experience in their purchase decisions.

Specifically, the journey stage includes a cognitive stage, an interest stage, a consideration stage, a decision stage, an action stage, a loyalty stage, and a recommendation stage. During the cognitive stage, the potential customer first comes into contact with the brand or product and begins to understand the relevant information. Enterprises increase brand awareness through advertising, social media, content marketing, and the like, and attract attention of potential customers. At the interest stage, potential customers are interested in brands or products, beginning to actively seek more information. Enterprises need to provide valuable content, such as detailed product information, customer evaluations, case studies, etc., to help potential customers better understand the value of a product. At the consideration stage, the customer begins to compare different choices, evaluating the brand and competitor's products. Enterprises may attract customers by providing trials, offers, detailed product comparisons, and the like, showing unique selling points of products. At the decision stage, the customer makes a purchase decision at this stage. At this point, enterprises need to provide clear purchase guidelines, price transparency, after-sales services, and the like to facilitate transactions. During the action stage, the customer completes the purchase and becomes a formal customer. Enterprises need to focus on the customer's purchase experience to ensure smooth delivery and good after-sales services to enhance customer satisfaction and loyalty. In the loyalty stage, after purchase, the goal of the brand is to convert the customer into a loyalty customer. The brand can enhance the loyalty of the customer through continuous customer care, membership system, high-quality after-sales service, and the like. At the recommendation stage, satisfactory customers will proactively recommend the brand to other potential customers, further promoting the dissemination of the brand.

The second step includes parsing the query request according to the request scenario and the process stage, and determining the object demand.

In the present implementation, the large language model combines the request scenario and the process stage, parses the query request of the target object, and determines the real and complete object demand of the target object.

It should be appreciated that the demand scenario and the process stage directly affect the object demand, and that the user demand is different for the same query request of the user when the user is at different process stages. For example, for a query request “smart watch”, the object demand of the target object in the cognitive stage is just want to know what the smart watch is, what basic functions it has, or what brands it has. Their knowledge of smart watches is still at an initial stage and there is no clear purchase intention. The object demand of the target object at the interest stage should be intended to understand the characteristics of a smart watch of a certain brand (e.g., Apple, Huawei), or specific information such as the durability and health monitoring function of the smart watch.

In the present implementation, the large language model determines the process stage of the target object in the demand scenario according to the object background information, and then analyzes the query request according to the demand scenario and the process stage to determine the object demand, thereby improving the accuracy of the object demand and providing an accurate data basis for a subsequent data query process.

In some alternative implementations of the present embodiment, the object background information includes a history query request of the target object within a first time period up to now, a first history data query result corresponding to the history query request, and first interactive behavior data of the target object with respect to the first history data query result.

The time length of the first time period may be specifically set according to the actual situation. The first interaction behavior data includes click, slide, dwell time, jump rate, purchase behavior, collection, sharing, and the like.

In general, the time length of the first time period is short, so that the large language model may determine an object demand of the target object based on a short-term change of the target object (e.g., a short-term change of interest of the target object).

In this implementation, the large language model may interact directly with the target object based on the dialog interface, or may interact indirectly with the target object in a form similar to the search box. The history query request in the first time period and the first history data query result corresponding to the history query request may be context data in the current session or cross-session context data.

In this embodiment, the execution body may perform the second step by the following way: parsing the query request and determining the object demand, based on the demand scenario, the process stage, the history query request, the first history data query result, and the first interaction behavior data.

On the basis of taking into account the demand scenario and the process stage, the large language model further considers historical query requests within the first time period, the first historical data query results, and the first interaction behavior data, so as to keenly perceive the short-term change data of the target object and further improve the accuracy of the object demand. This enables the subsequently determined data query results to more precisely conform to the demand change of the user, and enhances the user trust and satisfaction with the recommendation system.

In some alternative implementations of the present embodiment, the above execution body may execute the above determination procedure of the object demand by the following way.

First, a dynamic prompt word is generated based on a demand scenario, a process stage, a history query request, a first history data query result, and first interaction behavior data.

As an example, the execution subject may generate a dynamic prompt word based on the dynamic prompt word generation module 304 shown in FIG. 3, according to the demand scenario, the process stage, the historical query request, the first historical data query result, and the first interaction behavior data.

The dynamic prompt word generation module may be integrated in the language model, or may be independent of the large language model.

Then, based on the dynamic prompt word, the query request is parsed, and the object demand is determined.

In the present implementation, a dynamic prompt word is input to a large language model, and the large language model parses a query request under the guidance of the dynamic prompt word to determine an object demand of a target object.

In the present implementation, based on the dynamic prompt word, the large language model may more accurately understand the data such as the demand scenario, the process stage, the historical query request, the first historical data query result, and the first interactive behavior data, thereby contributing to further improving the accuracy of the object demand.
Step 202 includes: adjusting the query request according to the object demand, and generating an adjusted query request.

In this embodiment, the execution body may adjust the query request according to the object demand, and generate the adjusted query request.

As an example, when it is determined that the query request of the target object cannot fully express the object demand, for instance, some key demands in the object demand are omitted in the query request, then a completion operation is performed according to the omitted part. That is, the query request is expanded or continued to generate an adjusted query request.

As another example, when it is determined that the query request of the target object cannot accurately express the object demand, for example, some key demands in the object demand are incorrectly expressed in the query request, then a modification operation is performed according to the incorrect part. That is, the query request is rewritten to generate an adjusted query request.

In some alternative implementations of the present embodiment, the above execution body may perform the step 202 by adjusting the query request according to the object demand through the large language model, and generating the adjusted query request.

Based on the powerful logical reasoning and natural language understanding capabilities, the large language model can adjust the data that is either not clearly expressed or wrongly expressed in the query request based on the object demand, so as to rewrite or continue the query request and generate an adjusted query request

In the present implementation, the generation efficiency and accuracy of the adjusted query request are improved by the powerful logical reasoning and natural language understanding capability of the large language model.
Step 203 includes: performing a data query according to the adjusted query request to obtain a data query result.

In this embodiment, the execution body may perform data query according to the adjusted query request to obtain a data query result.

As an example, first, the above execution body may generate a query sentence for a database based on the adjusted query request. For instance, the query sentence could be an SQL (Structured Query Language) sentence for a structured database. The execution body parses the adjusted query request, extracts the key information and conditions therein, such as the query topic, the involved entities, the time range, the location, etc. According to the key information, the execution body constructs the corresponding SQL query sentence, then uses a database connection tool or a programming language (such as the SQLAlchemy library in Python) to establish a connection with the target database, sends the constructed SQL sentence to the database to execute the query operation, and obtains the data query result. Finally, the execution body conducts a preliminary processing of the data query result, such as removing duplicate data, filtering out irrelevant information, etc., and performs operations such as sorting, grouping, and summarizing the data as needed, so as to make the data query result more in line with the needs of the target object.

As another example, first, an adjusted query request represented in natural language is input into a data visualization tool (e.g., Tableau, Power BI, etc.) that supports natural language processing. The tool automatically parses the query request, identifies the key information therein, and converts the query request into corresponding query conditions and parameters. Then, the data visualization tool automatically connects to the corresponding data source (such as a database, a data warehouse, an Excel file, etc.) according to the set query conditions. The tool automatically executes the data query operation in the background and obtain the data that meets the query conditions from the data source. Finally, the tool uses its built-in intelligent analysis functions to automatically analyze the query results, such as trend analysis, correlation analysis, anomaly detection, etc. According to the analysis results, corresponding visual charts are automatically generated, such as line charts, bar charts, maps, etc., to intuitively display the change trends, distribution conditions, and interrelationships of the data.

In some alternative implementations of the present embodiment, the above execution body may perform the step 203 by the following way.

In a first step, a target search tool for processing an adjusted query request is determined from a search tool set by using a large language model.

The search tool set includes a variety of search tools, including but not limited to web search tools, video search tools, and product search tools. The search tool set may be supported by the tool module 302. The tool module encapsulates the task interface calls, enabling the large language model to conveniently call various search tools.

In some implementations, the tool module also has the ability of independent expansion, and new types of search tools may be added as needed to meet the needs of different users. As an example, the above execution body may provide the user with a search tool expansion interface, which includes filling item information such as the task interface of the search tool and the search function.

There is one or more target search tools.

In a second step, a data query is performed according to the adjusted query request by the target search tool to obtain a data query result.

The target search tool is called through the task interface corresponding to the target search tool, so that the target search tool performs data query according to the adjusted query request to obtain a data query result.

In the present implementation, the large language model automatically determines the target search tool for executing the data query, and executes the data query task through the appropriate search tool. This helps to improve the accuracy of the data query result and the adaptability of the data query result to the target object.

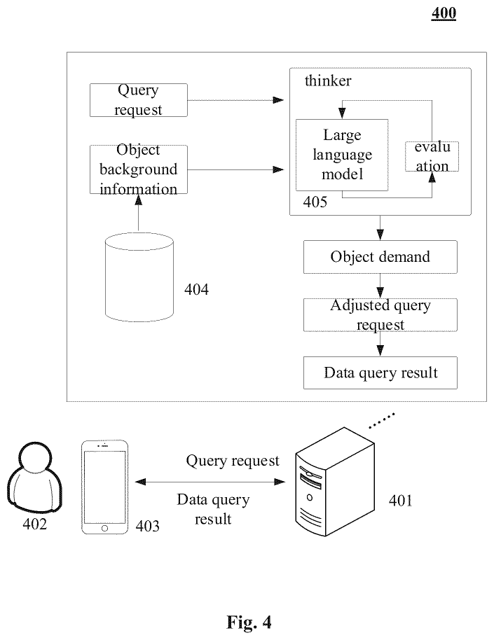

With continued reference to FIG. 4, FIG. 4 is a schematic diagram 400 of an application scenario of a data query method based on a large language model according to the present embodiment. First, the server 401 acquires a query request of a target object from a terminal device 403 corresponding to the target object 402; then, the object background information of the target object is determined from the background information database 404; according to the object background information of the target object, the query request of the target object is parsed by the large language model 405, to determine the object demand of the target object; the query request is adjusted according to the object demand, and an adjusted query request is generated; and the data query is performed according to the adjusted query request to obtain a data query result.

In the present embodiment, a data query method and apparatus based on a large language model are provided, in which a query request of a target object is parsed according to object background information of the target object by the large language model, to determine a real and complete object demand of the target; the query request is adjusted according to the object demand, and an adjusted query request capable of completely expressing the real requirement of the target object is generated; and the data query is performed according to the adjusted query request, and the data query result is conveniently obtained, thereby improving the acquisition efficiency and accuracy of the data query result and the matching degree between the data query result and the target object.

In some alternative implementations of the present embodiment, the execution body may further perform operations of: first determining a second history data query result corresponding to the target object and second interaction behavior data of the target object regarding the second history data query result within the second time period; and fine-tuning the language model based on the second history data query result and the second interaction behavior data.

The time length of the second time period may be set according to the actual situation. Generally, the time length of the second time period is greater than the time length of the first time period. The second interactive behavior data includes click, slide, dwell time, jump rate, purchase behavior, collection, sharing, and the like.

As an example, the execution body may select from the background information database 303 the second historical data query results corresponding to the target object within the second time period and the second interaction behavior data of the target object regarding the second historical data query results. The execution body intelligently organizes the information (the second historical data query results and the second interaction behavior data) as sample data, and continuously fine-tunes the large language model according to the sample data of the current service scenario (such as a specified vertical category). In this way, while providing search and recommendation services for end-users, the large language model in the current scenario can also be continuously fine-tuned and optimized, which helps to improve the data processing ability of the large language model in the target scenario.

In some alternative implementations of the present embodiment, the above execution body may also perform the following operations.

In the first step, whether the data query result satisfies the object demand and whether the data query result satisfies the preset structural requirement are determined through the large language model.

The preset structured requirements are characterized by a Schema 305. The large language model may refer to the data structured requirements presented by the final UI (User Interface) defined in Schema to determine whether the determined data query structure satisfies the data fields in the data structured requirements.

The large language model may parse the data query result, determine whether the data query result satisfies the object demand, and determine whether the data query result satisfies the preset structural requirement. When it is determined that the data query result does not satisfy the object demand and/or the data query result does not satisfy the preset structured requirement, an item that does not satisfy the object demand in the data query result and/or an item that does not satisfy the preset structured requirement in the data query result is determined.

A second step includes obtaining a supplementary query result by performing supplementary query according to the non-satisfactory item through the large language model in response to determining that the data query result does not satisfy the object demand or the preset structural requirement.

In response to determining that the data query result does not satisfy the object demand and/or the data query result does not satisfy the preset structured requirement, a supplementary query is performed according to the non-satisfactory term for the object demand in the data query result and/or the non-satisfactory term for the preset structured requirement in the data query result, so as to supplement the query data corresponding to the non-satisfactory item to obtain the supplementary query result.

A third step includes: updating the data query result according to the supplementary query result until the updated data query result meets the object demand and the preset structural requirement.

As an example, the supplementary query result is supplemented to the data query result to obtain an updated data query result.

In the present embodiment, the execution body may iteratively execute the first step and the third step until the final updated data query result meets the object demand and the preset structural requirement.

In the implementation, a data query process based on a large language model needs to undergo a rigorous verification process, so that a final output data query result meets an object demand and a preset structural requirement, and consistency, integrity and accuracy of the data query result are ensured.

In some alternative implementations of the present embodiment, the execution body may perform the above-mentioned second step by the following way.

First, a supplementary query request is determined based on non-satisfactory item by a large language model.

In the present implementation, the execution body may generate a supplementary query request for searching for a data requirement satisfying the non-satisfactory item by using a powerful logical reasoning capability and a natural language understanding capability of the large language model.

Specifically, the supplementary query request is determined by the large language model based on the non-satisfactory item, the demand scenario, the process stage, the historical query request, the first historical data query result, and the first interactive behavior data.

Then, a supplementary search tool for processing the supplementary query request is determined from the search tool set through the large language model.

Finally, data query is performed according to the supplementary query request by the supplementary search tool to obtain the supplementary query result.

The supplementary search tool may be one or more, which may be the same as or different from the target search tool. In this implementation, the determination process of the supplementary query result may be performed with reference to the determination process of the data query result based on the target search tool, and details are not described herein.

In the present implementation, a specific supplementary query method is provided. The supplementary query request and the supplementary search tool generated based on the large language model improve the determination efficiency and accuracy of the supplementary query result.

In some alternative implementations of the present embodiment, the execution body may execute the search process based on the target search tool by the following way.

First, the target search tool performs data query according to the adjusted query request to obtain an initial query result.

In this implementation, the target search tool is invoked through the task interface corresponding to the target search tool, so that the target search tool performs data query according to the adjusted query request to obtain the initial query result.

Then, the initial query result is filtered through the large language model according to the interaction behavior data of the target object with respect to the historical data query result, to obtain the data query result.

By analyzing the query results of the historical data of the target object and the data of the interaction behavior, the usage habits and preferences of the target object can be known, so that the calling strategy of the search tool can be adjusted, and the returned data query results are more valuable. Meanwhile, it is also possible to filter and screen the returned initial query result according to the historical feedback (interactive behavior data of the historical data query result) of the target user, so as to improve the quality and accuracy of the answer, and further improve the ability of the Thinker module to answer the query request of the target object.

The historical data query result may be the first historical data query result in the above implementation, may be the second historical data query structure, or may be the historical data query result of the target user in other time periods than the first time period and the second time period.

In the overall system shown in FIG. 3, there are two major driving engines, namely the large language model and the real-time user interaction data. After the system returns some search or recommendation results to the target object, the target object performs interaction behaviors such as “look at”, “look at carefully”, “scroll through quickly”, or “click to view more detailed data”. Based on these interaction behaviors, if the system records that the target object shows a mediocre response or no interest in a certain type of search results or the search results from a certain source, the large language model understands this and instructs the target search tool to reduce the data invocation from that source (for example, reducing the number of search results from that source, or no longer conducting data searches from that source).

It will be appreciated that for the supplemental query process of the supplemental search tool in the above implementation, the execution body may perform operations such as first performing a data query by supplemental search tool and supplemental query request to obtain an initial supplemental query result. Then, the initial supplementary query result is filtered through the large language model according to the interaction behavior data of the target object with respect to the historical data query result to obtain the supplementary query result.

In this implementation, for the initial query result obtained by searching of the search tool, the large language model is used to screen the interactive behavior data of the historical data query result according to the target object, so that the adaptability between the data query result and the target object is improved, and the efficiency of information acquisition based on the data query result by the target object is improved.

In some alternative implementations of the present embodiment, the execution body may further perform the following operations. First, a structured data query result is obtained; and then the structured data is displayed according to the preset display style and the data format.

As an example, first, the large language model may structure a data query result based on a data field in a preset structure requirement in Schema to obtain structured data; then based on the display style and the data format preset in the Schema, the card renderer (Card render) renders structured data according to the display style and the data format, and displays the rendered structured data through the terminal device corresponding to the target object.

In this implementation, based on the structure of the data query result, the display style requirement and the data format requirement, the display effect of the data query result is improved, and the information acquisition efficiency of the target object is further improved.

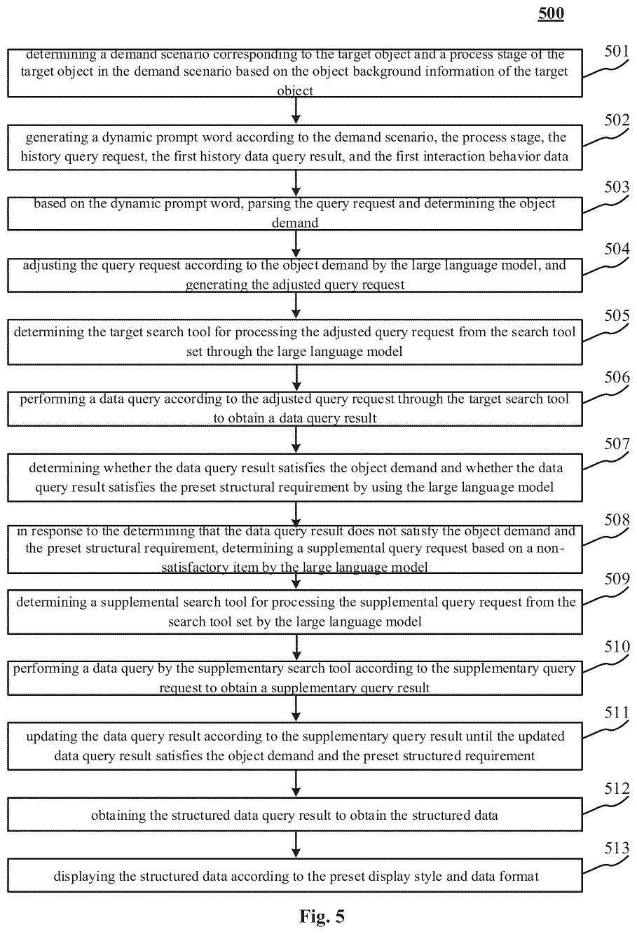

With continuing reference to FIG. 5, a schematic flow 500 of yet another embodiment of a data query method based on a large language model according to the present disclosure is shown. In process 500, the following steps are included.
Step 501 includes: determining a demand scenario corresponding to the target object and a process stage of the target object in the demand scenario based on the object background information of the target object.
Step 502 includes: generating a dynamic prompt word according to the demand scenario, the process stage, the history query request, the first history data query result, and the first interaction behavior data.

The object background information includes a history query request of the target object in a first time period up to now, a first history data query result corresponding to the history query request, and first interaction behavior data of the target object with respect to the first history data query result.
Step 503 includes: based on the dynamic prompt word, parsing the query request and determining the object demand.
Step 504 includes: adjusting the query request according to the object demand by the large language model, and generating the adjusted query request.
Step 505 includes: determining the target search tool for processing the adjusted query request from the search tool set through the large language model.
Step 506 includes: performing a data query according to the adjusted query request through the target search tool to obtain a data query result.
Step 507 includes: determining whether the data query result satisfies the object demand and whether the data query result satisfies the preset structural requirement by using the large language model.
Step 508 includes: in response to the determining that the data query result does not satisfy the object demand and the preset structural requirement, determining a supplemental query request based on a non-satisfactory item by the large language model.
Step 509 includes: determining a supplemental search tool for processing the supplemental query request from the search tool set by the large language model.
Step 510 includes: performing a data query by the supplementary search tool according to the supplementary query request to obtain a supplementary query result.
Step 511 includes: updating the data query result according to the supplementary query result until the updated data query result satisfies the object demand and the preset structured requirement.
Step 512 includes: obtaining the structured data query result to obtain the structured data.
Step 513 includes: displaying the structured data according to the preset display style and data format.

The process 500 of the data query method based on the large language model in this embodiment specifically illustrates the determination process of the object demand, the data query process based on the target search tool, the supplementary query process based on the supplementary search tool, as well as the structuring process and display process of the data query results. This further improves the acquisition efficiency and accuracy of the data query results, as well as the matching degree between the data query results and the target object.

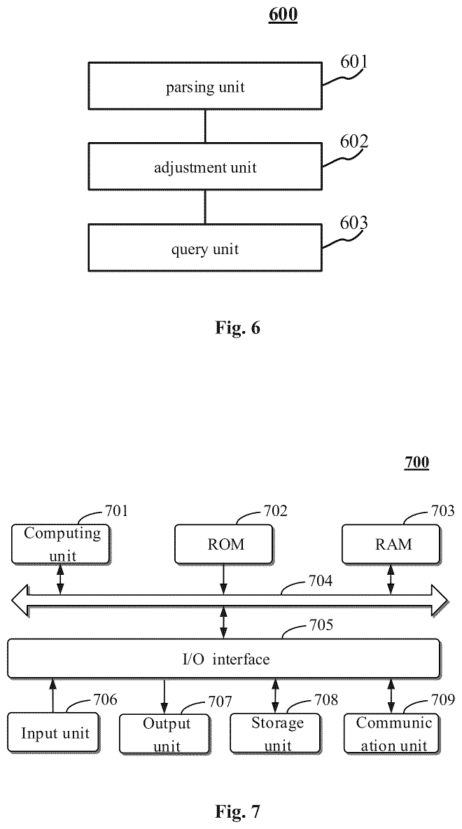

With continued reference to FIG. 6, as an implementation of the method shown in each of the above figures, the present disclosure provides an embodiment of a data query apparatus based on a large language model, which corresponds to the method embodiment shown in FIG. 2 and which is particularly applicable to various electronic devices.

As shown in FIG. 6, a data query apparatus 600 based on a large language model includes a parsing unit 601 configured to parse a query request of a target object and determine an object demand of the target object, according to object background information of the target object by using the large language model; an adjustment unit 602 configured to adjust the query request according to the object demand to generate an adjusted query request; and a query unit 603 configured to perform a data query according to the adjusted query request to obtain a data query result.

In some alternative implementations of the present embodiment, the parsing unit 601 is further configured to determine an demand scenario corresponding to the target object and a process stage of the target object in the demand scenario according to the object background information of the target object; and according to the demand scenario and the process stage, parse the query request and determine the object demand.

In some alternative implementations of the present embodiment, the object background information includes a history query request of the target object within a first time period up to now, a first history data query result corresponding to the history query request, and first interaction behavior data of the target object with respect to the first history data query result; and the parsing unit 601 is further configured to parse the query request and determine the object demand, based on the demand scenario, the process stage, the history query request, the first history data query result, and the first interaction behavior data.

In some alternative implementations of the present embodiment, the parsing unit 601 is further configured to generate a dynamic prompt word according to a demand scenario, a process stage, a history query request, a first history data query result, and first interaction behavior data; and parse the query request and determine the object demand according to the dynamic prompt word.

In some alternative implementations of the present embodiment, the apparatus further includes a fine-tuning unit (not shown in the figure), which is configured to: determine the second historical data query result corresponding to the target object within the second time period and the second interaction behavior data of the target object regarding the second historical data query result; and fine-tune the large language model according to the second historical data query result and the second interaction behavior data.

In some alternative implementations of the present embodiment, the adjustment unit 602 is further configured to adjust the query request according to the object demand by using the large language model, and generate the adjusted query request.

In some alternative implementations of the present embodiment, the query unit 603 is further configured to determine the target search tool for processing the adjusted query request from the search tool set through the large language model; and perform, by using target search tool, data query according to the adjusted query request to obtain a data query result.

In some alternative implementations of the present embodiment, the apparatus further includes a determination unit (not shown) configured to determine, by a large language model, whether the data query result satisfies the object demand and whether the data query result satisfies the preset structured requirement; a supplemental query unit (not shown) configured to perform a supplemental query according to a non-satisfactory item by the large language model to obtain a supplemental query result, in response to determining that the data query result does not satisfy the object demand or the preset structural requirement; and an updating unit (not shown in the figure) is configured to update the data query result according to the supplementary query result until the updated data query result satisfies an object demand and a preset structured requirement.

In some alternative implementations of the present embodiment, the supplemental query unit is further configured to determine the supplemental query request based on the non-satisfactory item by the large language model; determine a supplemental search tool for processing a supplemental query request from a search tool set through the large language model; and perform a data query according to the supplementary query request by the supplementary search tool to obtain the supplementary query result.

In some alternative implementations of the present embodiment, the query unit 603 is further configured to perform a data query according to the adjusted query request by the target search tool to obtain an initial query result; and filter the initial query result according to the interaction behavior data of the target object with respect to the historical data query result through the large language model to obtain the data query result.

In some alternative implementations of the present embodiment, the apparatus further includes a structured unit (not shown) configured to query the results of the structured data to obtain structured data; and a display unit (not shown) is configured to display structured data according to a preset display pattern and a data format.

In the present embodiment, there is provided a data query apparatus based on a large language model. Through the large language model, according to the object background information of the target object, the query request of the target object is parsed to determine the real and complete object demand of the target object. According to the object demand, the query request is adjusted to generate an adjusted query request that can fully express the real demand of the target object. Data query is performed according to the adjusted query request, and the data query result can be obtained conveniently, which improves the acquisition efficiency and accuracy of the data query result, as well as the matching degree between the data query results and the target object.

According to an embodiment of the present disclosure, the present disclosure further provides an electronic device including at least one processor; and a memory in communication with the at least one processor. The memory stores instructions executable by the at least one processor to enable the at least one processor to implement the data query method based on a large language model described in any of the above embodiments when executed.

According to an embodiment of the present disclosure, the present disclosure also provides a readable storage medium storing computer instructions for enabling a computer to implement the data query method based on a large language model described in any of the above embodiments when executed.

Embodiments of the present disclosure provide a computer program product that, when executed by a processor, is capable of implementing the data query method based on a large language model described in any of the above embodiments.

FIG. 7 shows a schematic block diagram of an example electronic device 700 that may be used to implement embodiments of the present disclosure. Electronic devices are intended to represent various forms of digital computers, such as laptop computers, desktop computers, worktables, personal digital assistants, servers, blade servers, mainframe computers, and other suitable computers. Electronic devices may also represent various forms of mobile devices, such as personal digital processing, cellular telephones, smart phones, wearable devices, and other similar computing devices. The components shown herein, their connections and relationships, and their functions are by way of example only and are not intended to limit the implementation of the disclosure described and/or claimed herein.

As shown in FIG. 7, the device 700 includes a computing unit 701, which may perform various appropriate actions and processes according to a computer program stored in a read-only memory (ROM) 702 or a computer program loaded into a random access memory (RAM) 703 from a storage unit 708. In RAM 703, various programs and data required for operation of the device 700 may also be stored. The calculation units 701, ROM 702 and RAM 703 are connected to each other via a bus 704. An input/output (I/O) interface 705 is also connected to bus 704.

A plurality of components in the device 700 are connected to the I/O interface 705, including an input unit 706, such as a keyboard, a mouse, and the like; an output unit 707, for example, various types of displays, speakers, and the like; a storage unit 708, such as a magnetic disk, an optical disk, or the like; and a communication unit 709, such as a network card, a modem, or a wireless communication transceiver. The communication unit 709 allows the device 700 to exchange information/data with other devices over a computer network such as the Internet and/or various telecommunications networks.

The computing unit 701 may be various general-purpose and/or special-purpose processing components having processing and computing capabilities. Some examples of computing units 701 include, but are not limited to, central processing units (CPUs), graphics processing units (GPUs), various specialized artificial intelligence (AI) computing chips, various computing units running machine learning model algorithms, digital signal processors (DSPs), and any suitable processors, controllers, microcontrollers, and the like. The calculation unit 701 performs various methods and processes described above, such as a data query method based on a large language model. For example, in some embodiments, a data query method based on a large language model may be implemented as a computer software program tangibly embodied in a machine-readable medium, such as a storage unit 708. In some embodiments, some or all of the computer program may be loaded and/or installed on the device 700 via the ROM 702 and/or the communication unit 709. When the computer program is loaded into the RAM 703 and executed by the calculation unit 701, one or more steps of the data query method based on a large language model described above may be performed. Alternatively, in other embodiments, the computing unit 701 may be configured to perform a data query method based on a large language model by any other suitable means (e.g., by means of firmware).

The various embodiments of the systems and techniques described above herein may be implemented in a digital electronic circuit system, an integrated circuit system, a field programmable gate array (FPGA), an application specific integrated circuit (ASIC), a special purpose standard product (ASSP), a system on a system on a chip (SOC), a load programmable logic device (CPLD), computer hardware, firmware, software, and/or combinations thereof. These various embodiments may include being implemented in one or more computer programs that may execute and/or interpret on a programmable system including at least one programmable processor, which may be a dedicated or general purpose programmable processor, may receive data and instructions from a memory system, at least one input device, and at least one output device, and transmit the data and instructions to the memory system, the at least one input device, and the at least one output device.

The program code for carrying out the methods of the present disclosure may be written in any combination of one or more programming languages. These program codes may be provided to a processor or controller of a general purpose computer, special purpose computer, or other programmable large language model-based data query device such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include one or more line-based electrical connections, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination of the foregoing.

To provide interaction with a user, the systems and techniques described herein may be implemented on a computer having a display device (e.g., a CRT (cathode ray tube) or LCD (liquid crystal display) monitor) for displaying information to the user; and a keyboard and a pointing device (e.g., a mouse or a trackball) through which a user can provide input to a computer. Other types of devices may also be used to provide interaction with a user; For example, the feedback provided to the user may be any form of sensory feedback (e.g., visual feedback, auditory feedback, or tactile feedback); and input from the user may be received in any form, including acoustic input, speech input, or tactile input.

The systems and techniques described herein may be implemented in a computing system including a background component (e.g., as a data server), or a computing system including a middleware component (e.g., an application server), or a computing system including a front-end component (e.g., a user computer having a graphical user interface or a web browser through which a user may interact with embodiments of the systems and techniques described herein), or a computing system including any combination of such background component, middleware component, or front-end component. The components of the system may be interconnected by any form or medium of digital data communication (e.g., a communication network). Examples of communication networks include a local area network (LAN), a wide area network (WAN), and the Internet.

The computer system may include a client and a server. The client and server are typically remote from each other and typically interact through a communication network. The relationship between the client and the server is generated by a computer program running on the corresponding computer and having a client-server relationship with each other. A server may be a cloud server, also referred to as a cloud computing server or a cloud host, and is a host product in a cloud computing service system, so as to resolve a defect that a conventional physical host and a VPS (Virtual Private Server) service are difficult to manage, and service scalability is weak; It may also be a server of a distributed system or a server incorporating a chain of blocks.

According to the technical solution of the embodiment of the present disclosure, there is provided a data query method and apparatus based on a large language model, where a query request of a target object is parsed according to object background information of the target object through the large language model, and a real and complete object demand of the target object is determined; the query request is adjusted according to the object demand, and an adjusted query request capable of completely expressing the real requirement of the target object is generated; The data query is performed according to the adjusted query request, and the data query result is conveniently obtained, thereby improving the acquisition efficiency and accuracy of the data query result and the matching degree between the data query result and the target object.

It is to be understood that the steps of reordering, adding or deleting may be performed using the various forms shown above. For example, the steps described in the present disclosure may be performed in parallel or sequentially or in a different order, so long as the desired results of the technical solution provided in the present disclosure can be realized, and no limitation is imposed herein.

The foregoing detailed description is not intended to limit the scope of the present disclosure. It will be appreciated by those skilled in the art that various modifications, combinations, sub-combinations, and substitutions may be made depending on design requirements and other factors. Any modifications, equivalents, and modifications that fall within the spirit and principles of the disclosure are intended to be included within the scope of protection of the disclosure.

What is claimed is:

1. A data query method based on a large language model, the method comprising:
parsing a query request of a target object and determining an object demand of the target object, based on object background information of the target object by using the large language model;
adjusting the query request to generate an adjusted query request according to the object demand; and
performing a data query according to the adjusted query request to obtain a data query result.

2. The method according to claim 1, wherein the parsing the query request of the target object and determining the object demand of the target object, based on the object background information of the target object comprises:
determining a demand scenario corresponding to the target object and a process stage of the target object in the demand scenario according to the object background information of the target object; and
parsing the query request according to the demand scenario and the process stage, and determining the object demand.

3. The method according to claim 2, wherein the object background information comprises a history query request of the target object within a first time period up to now, a first history data query result corresponding to the history query request, and first interactive behavior data of the target object with respect to the first history data query result; and
the parsing the query request according to the demand scenario and the process stage, and determining the object demand comprises:
parsing the query request according to the demand scenario, the process stage, the history query request, the first history data query result, and the first interaction behavior data, and determining the object demand.

4. The method according to claim 3, wherein the parsing the query request according to the demand scenario, the process stage, the history query request, the first history data query result, and the first interaction behavior data, and determining the object demand comprises:
generating a dynamic prompt word according to the demand scenario, the process stage, the history query request, the first history data query result, and the first interaction behavior data; and
parsing the query request according to the dynamic prompt word, and determining the object demand.

5. The method according to claim 1, further comprising:
determining a second historical data query result corresponding to the target object in a second time period and second interactive behavior data of the target object with respect to the second historical data query result; and
fine-tuning the large language model according to the second history data query result and the second interaction behavior data.

6. The method according to claim 1, wherein the adjusting the query request to generate the adjusted query request based on the object demand comprises:
adjusting the query request according to the object demand by the large language model, to generate the adjusted query request.

7. The method according to claim 1, wherein the performing the data query according to the adjusted query request to obtain the data query result comprises:
determining a target search tool for processing the adjusted query request from a search tool set by the large language model; and
performing the data query according to the adjusted query request by the target search tool to obtain the data query result.

8. The method according to claim 1, further comprising:
determining, by the large language model, whether the data query result satisfies the object demand and whether the data query result satisfies a preset structural requirement;
in response to determining that the data query result does not satisfy the object demand or the preset structural requirement, performing a supplementary query according to a non-satisfactory item by the large language model to obtain a supplementary query result; and
updating the data query result according to the supplementary query result until the updated data query result satisfies the object demand and the preset structural requirement.

9. The method according to claim 8, wherein the performing the supplementary query according to the non-satisfactory item by the large language model to obtain the supplementary query result comprises:
determining a supplemental query request based on the non-satisfactory item by the large language model;
determining a supplemental search tool for processing the supplemental query request from the search tool set by the large language model; and
performing a data query according to the supplementary query request by the supplementary search tool to obtain the supplementary query result.

10. The method according to claim 7, wherein the performing the data query according to the adjusted query request to obtain the data query result comprises:
performing a data query according to the adjusted query request by the target search tool to obtain an initial query result; and
filtering the initial query result according to interaction behavior data of the target object with respect to historical data query result by the large language model to obtain the data query result.

11. The method according to claim 1, further comprising:
structuring the data query result to obtain structured data; and
displaying the structured data according to a preset display style and data format.

12. An electronic device, comprising:
at least one processor; and
a memory in communication with the at least one processor;
wherein the memory stores instructions executable by the at least one processor to enable the at least one processor to perform operations comprising:
parsing a query request of a target object and determining an object demand of the target object, based on object background information of the target object by using the large language model;
adjusting the query request to generate an adjusted query request according to the object demand; and
performing a data query according to the adjusted query request to obtain a data query result.

13. The electronic device according to claim 12, wherein the parsing the query request of the target object and determining the object demand of the target object, based on the object background information of the target object comprises:
determining a demand scenario corresponding to the target object and a process stage of the target object in the demand scenario according to the object background information of the target object; and
parsing the query request according to the demand scenario and the process stage, and determining the object demand.

14. The electronic device according to claim 13, wherein the object background information comprises a history query request of the target object within a first time period up to now, a first history data query result corresponding to the history query request, and first interactive behavior data of the target object with respect to the first history data query result; and
the parsing the query request according to the demand scenario and the process stage, and determining the object demand comprises:
parsing the query request according to the demand scenario, the process stage, the history query request, the first history data query result, and the first interaction behavior data, and determining the object demand.

15. The electronic device according to claim 14, wherein the parsing the query request according to the demand scenario, the process stage, the history query request, the first history data query result, and the first interaction behavior data, and determining the object demand comprises:
generating a dynamic prompt word according to the demand scenario, the process stage, the history query request, the first history data query result, and the first interaction behavior data; and
parsing the query request according to the dynamic prompt word, and determining the object demand.

16. The electronic device according to claim 12, further comprising:
determining a second historical data query result corresponding to the target object in a second time period and second interactive behavior data of the target object with respect to the second historical data query result; and
fine-tuning the large language model according to the second history data query result and the second interaction behavior data.

17. The electronic device according to claim 12, wherein the adjusting the query request to generate the adjusted query request based on the object demand comprises:
adjusting the query request according to the object demand by the large language model, to generate the adjusted query request.

18. A non-transitory computer-readable storage medium storing computer instructions for causing the computer to operations comprising:
parsing a query request of a target object and determining an object demand of the target object, based on object background information of the target object by using the large language model;
adjusting the query request to generate an adjusted query request according to the object demand; and
performing a data query according to the adjusted query request to obtain a data query result.
